(19) United States
(12) Patent Application Publication
(10) Pub. No.: US 2025/0104265 A1
(43) Pub. Date: Mar. 27, 2025

(54) SYSTEM AND METHOD FOR LOCATION OBFUSCATION

(71) Applicant: SIGNIFY HOLDING B.V., EINDHOVEN (NL)

(72) Inventors: JIN YU, LEXINGTON, MA (US); PETER DEIXLER, ARLINGTON, MA (US)

(21) Appl. No.: 18/836,460

(22) PCT Filed: Feb. 8, 2023
(86) PCT No.: PCT/EP2023/053064

§ 371 Date: Aug. 7, 2024

Related U.S. Application Data
(60) Provisional application No. 63/308,604, filed on Feb. 10, 2022.

(30) Foreign Application Priority Data
May 30, 2022 (EP) 22176016.8

(51) Int. Cl. G06T 7/70; G01S 5/16; H04B 10/116

(52) U.S. Cl. CPC G06T 7/70; G01S 5/16; H04B 10/116; G06T 2207/20081; G06T 2207/30196

(57) ABSTRACT

A system (100) for obfuscation of a position of at least one subject (110) in an indoor space (120), comprising a plurality of light sources (130) configured to emit modulated illumination, a mobile device (150) arranged to be portable by the at least one subject, configured to capture image(s) (156) comprising the modulated illumination, a server (160) configured to receive first image(s) (152) and determine a location of the mobile device(s), receive information related to zone(s) of the indoor space, predetermined privacy level(s) and privacy threshold level(s), and to perform a processing of the image(s) and a determination of an accuracy of the location of the mobile device(s), train a machine learning, ML, model by inputting the determined accuracy, wherein the mobile device is further configured to perform a processing of a captured second image(s) (154) by the trained ML model.

### FIELD OF THE INVENTION

The present invention generally relates to location obfuscation of one or more subjects. More specifically, the present invention is related to location obfuscation of one or more persons via mobile device(s) portable by the person(s) in an indoor space.

### BACKGROUND OF THE INVENTION

In an Interact Retail Visual/Visible Light Communication (VLC) system, mobile phone apps or dedicated handheld devices (e.g. self-scanners) will likely be used in the future in indoor spaces. For example, in case of the indoor space is a warehouse, store, or the like, the system may enhance the shopping experience and increase sales. However, customer related data may not be available due to privacy and/or economic reasons. Furthermore, there may be privacy concerns among the customers, and retailers often have a desire to hide the customers' precise whereabouts from unauthorized third party privacy-invasive analytics, which for instance may try to track the motion trail of a handheld device through the warehouse, store or shop and then associate the motion trail to a unique customer identity (e.g. captured by one or more cameras at the door(s) of the store or shop).

There are techniques in the prior art which are able to obtain, at statistical level, insights about the type of motion trails of one or more customers in a store or shop. In other words, these insights are provided at aggregated levels, but not at unique personal levels.

However, there is a wish to further develop the technology in this area for the ability to obtain data related to the customers' position(s) in an indoor space such as a warehouse, store or shop, e.g. in order to develop services based on such data, without compromising privacy rules or regulations.

In connection with the determination of customers' position(s) without compromising privacy rules or regulations, there is a wish to make the process of this determination more efficient. More specifically, it is desirable to improve the management of the determination of customers' position(s).

Hence, it is an object of the present invention to provide an efficient management of a process related to the determination of subjects' position(s) in an indoor space without compromising privacy rules or regulations with respect to the subjects (e.g. persons/customers).

CN105898056A discloses a picture hiding method and a device with a picture hiding function. The picture hiding method in a mobile communication terminal comprises steps: the mobile communication terminal is provided, wherein the mobile communication terminal stores a to-be-hidden first picture; the position of the mobile communication terminal is judged; according to the position of the mobile communication terminal, whether the first picture needs to be hidden is judged; if the first picture is judged to need to be hidden, the first picture is hidden according to the picture hiding method; and if the first picture is judged to need to be hidden, the first picture is displayed normally.

### SUMMARY OF THE INVENTION

It is of interest to further develop the technology in the area of monitoring or observing the position(s) of subject(s) (e.g. person(s)) in an indoor space without compromising privacy rules or regulations with respect to the subject(s), and by providing an efficient management of such a process.

This and other objects are achieved by providing a system and a method having the features in the independent claims. Preferred embodiments are defined in the dependent claims.

According to a first aspect of the present invention, there is provided a system for obfuscation of a position of at least one subject in an indoor space. The system comprises a plurality of light sources, wherein each light source of the plurality of light sources is configured to emit modulated illumination. The system further comprises at least one mobile device arranged to be portable by the at least one subject, wherein each mobile device of the at least one mobile device is configured to receive the modulated illumination from at least one light source of the plurality of light sources and capture a plurality of images comprising the modulated illumination. The system further comprises a server communicatively coupled to the at least one mobile device, wherein the server is configured to receive at least one first image from the at least one mobile device and determine a location of the at least one mobile device based on the modulated information of the at least one first image, and receive information related to at least one zone of the indoor space, wherein the information comprises a predetermined privacy level associated with each zone of the at least one zone and a privacy threshold level. The server is further configured to determine if the determined location of the at least one mobile device is within a zone of the indoor space, and if the determined location of the at least one mobile device is within the zone of the indoor space, determine if the privacy level associated with the zone is above the privacy threshold level, and if the privacy level associated with the zone is above the privacy threshold level, configured to perform a processing of the at least one first image by at least one of a shifting of at least one portion of the at least one first image and an obfuscation of the at least one first image. The server is further configured to determine an offset in accuracy of the location of the at least one mobile device based on the processing of the at least one first image. The server is further configured to train a machine learning, ML, model by inputting the offset in accuracy of the location of the at least one mobile device based on the processing of the at least one first image. The at least one mobile device is further configured to perform a processing of at least one second image of the plurality of images by the trained machine learning, ML, model.

According to a second aspect of the present invention, there is provided a method for obfuscation of a position of at least one subject in an indoor space via a system comprising a plurality of light sources, wherein each light source of the plurality of light sources is configured to emit modulated illumination, and at least one mobile device arranged to be portable by the at least one subject, wherein each mobile device of the at least one mobile device is configured to receive the modulated illumination from at least one light source of the plurality of light sources and capture a plurality of images comprising the modulated illumination. The method comprises receiving at least one first image from the at least one mobile device and determining a location of the at least one mobile device based on the modulated information of the at least one first image, and receiving information related to at least one zone of the indoor space, wherein the information comprises a predetermined privacy level associated with each zone of the at least one zone and a privacy threshold level. The method further comprises determining if the determined location of the at least one mobile device is within a zone of the indoor space, and if the determined location of the at least one mobile device is within the zone of the indoor space, determining if the privacy level associated with the zone is above the privacy threshold level. If the privacy level associated with the zone is above the privacy threshold level, performing a processing of the at least one first image by at least one of a shifting of at least a portion of the at least one first image, and an obfuscation of the at least one first image. The method further comprises performing a determination of an offset in accuracy of the location of the at least one mobile device based on the processing of the at least one first image. The method further comprises training of a machine learning, ML, model by inputting the offset in accuracy of the at least one mobile device based on the processing of the at least one first image and outputting the processed at least one first image. The method further comprises performing, via the at least one mobile device, a processing of at least one second image of the plurality of images via the trained machine learning, ML, model.

Thus, the present invention is based on the idea of providing a system for obfuscation of a position of one or more subjects (e.g. person(s)) in an indoor space. The mobile device(s) of the subject(s) may obfuscate one or more captured images for position determination from the VLC system via the machine learning, ML, model which has been trained by inputting accuracy offset determinations of images, wherein these images have been processed in case it has been determined that the mobile device(s) (i.e. subject(s)/person(s)) has (have) been present in zone(s) associated with a relatively high privacy. The training phase may comprise using superivsed/unsupervised learning algorithms available in the art. Different dataset may be used for training. For example different images and an accuracy offset determinations of images are used to train the model. The trained machine learning model may be deployed in the mobile device(s).

Hence, the mobile device(s) may hereby manage image obfuscation in an efficient manner via the machine learning, ML, model which determines to what extent the processing (i.e. shifting/obfuscation) of the image(s) is required. From the trained machine learning, ML, model, the mobile device(s) may conveniently and efficiently perform the image obfuscation, and may thereafter, for example, send the obfuscated image(s) for any further analysis and/or processing.

The present invention is advantageous in that the mobile device(s) may receive knowledge of to what extent a captured image should be processed (i.e. shifted and/or obfuscated) dependent on the privacy level of the zone of the indoor space in which the mobile device(s) is positioned. Hence, as the indoor space may comprise and/or be divided into one or more zones having different privacy levels associated therewith, the system is convenient and efficient in determining the extent of location obfuscation of subject(s) in the indoor space.

A system for obfuscation of a position of at least one subject in an indoor space may use visible light communication (VLC) based localization. The VLC-based localization/positioning is a well known term in the art. Unlike a radiofrequency based localization/positioning, which e.g., determines the location locally on the processor chip of the mobile device(s), VLC positioning must be determined in the cloud/server computer since it requires very detailed high-resolution images of the indoor space which for instance cannot be transmitted to the mobile device(s) due to e.g., high data traffic. Therefore, obfuscation of the image on the mobile device(s) needs to be managed for example before they are transmitted to the cloud/server whereas the obfuscation needs to shift the image enough for privacy but no impact on the navigation. With VLC, the obfuscation is different and more complex as it is a combination between the cloud/server and the (VLC) mobile device(s). Therefore, the ‘clear’ (unshifted) image may not be directly send to the cloud/server for the privacy sensitive areas. A machine learning model approach may be advantageously used, wherein the machine learning model may characterize how much image shift is required for the desired obfuscation, which will depend e.g., on the ceiling high, light source distance, view angle, etc. The mobile device(s) may be used to transmit the un-obfuscated image and then to learn how image can be shifted to get the desired shift for this specific location in the indoor pace. Subsequently, the cloud/server-part of the system lets the mobile device(s) know how much it should shift the image to obfuscate them before transmission to the cloud. In this way the mobile device(s) will get granular guidance how much to shift for certain areas.

The system according to the present invention is provided for obfuscation of a position of at least one subject (e.g. one or more persons) in an indoor space. By the term “obfuscation”, it is hereby meant a change, disruption, blurring, or the like, of the (true or real) position(s) of the person(s). The system comprises a plurality of light sources, wherein each light source of the plurality of light sources is configured to emit modulated illumination. By the term “modulated illumination”, it is hereby meant signal(s) and/or code(s) embedded in the illumination, a concept well known by the skilled person. The system further comprises at least one mobile device arranged to be portable by the at least one subject. The mobile device may be substantially any device intended to be carried (portable) by a subject (person), such as a WTRU (e.g. mobile phone), a self-scanning device, etc. Hence, the mobile device may be the subject's (personal) device, or the mobile device may alternatively be a device provided by the business of the indoor space, e.g. a self-scanning device or a (professional) scanner device. At least one of mobile device of the at least one mobile device is configured to receive the modulated illumination from at least one light source of the plurality of light sources and capture a plurality of images comprising the modulated illumination. The system further comprises a server communicatively coupled to the at least one mobile device, wherein the server is configured to receive the at least one first image from the at least one mobile device. Hence, the mobile device(s) is (are) arranged or configured to send the first image(s) to a server which is configured to receive the first image(s) sent. The server is further configured to determine a location of the at least one mobile device based on the modulated information of the at least one first image. The server is further configured to receive information related to at least one zone of the indoor space, wherein the information comprises a predetermined privacy level associated with each zone of the at least one zone and a privacy threshold level. By “predetermined privacy level” it is here meant a level associated with privacy, integrity and/or sensitivity. Hence, each defined zone of the indoor space is associated with a level of privacy which is set in advance. The zone(s) of the indoor space may be (an) area(s) (i.e. 2D) or (a) spatial zone(s) (i.e. 3D). The server is further configured to determine if the determined location of the at least one mobile device is within a zone of the indoor space. If the determined location of the at least one mobile device is within the zone of the indoor space, the server is configured to determine if the privacy level associated with the zone is above the privacy threshold level. If the privacy level associated with the zone is above the privacy threshold level, the server is configured to perform a processing of the at least one first image by at least one of a shifting of at least a portion of the at least one first image and an obfuscation of the at least one first image. Hence, the server is configured to perform a processing of the first image(s) by shifting of at least a portion of the first image(s) and/or an obfuscation of the first image(s). The server is further configured to perform a determination of an offset in accuracy of the location of the at least one mobile device based on the processing of the at least one first image. In other words, the server is configured to perform the determination of an offset in accuracy based on the first image(s) and the processed first image(s). If the server determines that the zone in which the mobile device(s) (and hence the subject(s)/person(s)) is (are) present has a (relatively high) privacy level which is above the privacy threshold level, the server is configured to perform image processing by image shifting and/or image obfuscation, as well as a determination of an offset in accuracy of the location of the mobile device(s) based on the processed first image(s). The server is further configured to train a machine learning, ML, model by inputting the offset in accuracy of the location of the at least one mobile device based on the processing of the at least one first image. Hence, the ML model, which may comprise a neural network, a regression model, or the like, is trained by the offset in accuracy of the location of the mobile device(s) as input. The at least one mobile device is further configured to perform a processing of at least one second image of the plurality of images via the trained machine learning, ML, model. Hence, the mobile device(s) is (are) configured to perform a processing of the captured second image(s) by the trained ML model. Hence, the mobile device(s) itself (themselves) process the second image(s) by inputting the captured second image(s) into the trained ML model such that the received output from the trained ML model is/becomes processed (i.e. shifted and/or obfuscated) second image(s), wherein the second image(s) as processed may be sent to the server.

According to an embodiment of the present invention, the indoor space may be one of a warehouse, a supermarket, a shop, and a store. The present embodiment is advantageous in that much information may be obtained from the position of the mobile device(s), and hence of the person(s) equipped with the mobile device(s), in a commercial indoor space. One of the most prominent advantages of the present embodiment is a clear, distinct and/or differentiated relation between the zones of a commercial indoor space and the privacy level thereof, as a zone comprising a particular kind of goods, items, etc., may be related to a higher level of privacy than another zone comprising other kinds or sorts of goods, items, etc. For example, a zone comprising everyday goods such as vegetables, dairy products, pet foods, etc., may be associated with a relatively low privacy level, whereas a zone comprising goods related to intimacy and/or privacy such as maternity tests, drugs/medicaments, etc., may be associated with a relatively high privacy level.

According to an embodiment of the present invention, the at least one mobile device may be one of a wireless transmit/receive unit, WTRU, a wearable device, and a scanning device. For example, the scanning device may be a handheld scanning device or an integrated scanning device, e.g. a scanning device integrated in a shopping trolley. The mobile device(s) of the present embodiment in the form of WTRUs, such as mobile telephone(s), is advantageous in that mobile device(s) of this kind are ubiquitously used and carried by people. The mobile device(s) of the present embodiment may alternatively be a device provided by the business of the indoor space, e.g. a self-scanning device or a (professional) scanner (or scanning) device. By the term “wearable device”, it is here meant an electronic device arranged to be worn by a subject (person). The mobile device(s) of the present embodiment in the form of handheld (self) scanning device(s) is advantageous in that these are frequently used and carried by people in commercial indoor spaces such as warehouses, supermarkets, shops, and/or stores.

According to an embodiment of the present invention, the shifting of the at least a portion of the at least one first image may comprise random shifting of pixels of the at least a portion of the at least one first image. The present embodiment is advantageous in that the randomness of the technology inherently contributes to the level of safeguarded privacy and/or integrity of the person(s), and may consequently satisfy privacy rules or regulations, or at least increase the likelihood of meeting such rules and regulations.

According to an embodiment of the present invention, the obfuscation of the at least one first image may be performed as a function of the privacy level associated with the zone. For example, the server may be configured to perform a (relatively) high level or degree of obfuscation of the image(s) in case a (relatively) high privacy level is associated with the zone, and analogously, be configured to perform a (relatively) low level or degree of obfuscation of the image(s) in case a (relatively) low privacy level is associated with the zone. The present embodiment is advantageous in that the level or degree of obfuscation is conveniently adapted to the privacy level of the zone, which further increases the privacy or integrity of the person(s) present in the zone.

According to an embodiment of the present invention, the obfuscation of the at least one first image may comprise at least one of a masking and a blurring of the at least one image. By the term “masking”, it is here meant an image processing technique for hiding and/or revealing one or more portions of an image. For example, a masked image by the obfuscation performed by the server may result in an image where some of the pixel intensity values are zero, and others are non-zero. Wherever the pixel intensity value is zero in the image, then the pixel intensity of the resulting masked image may be set to the background value (normally zero).

According to an embodiment of the present invention, the server may be configured to determine the location of the at least one mobile device by one of a triangulation, trilateration, multilateration, and fingerprinting process. Hence, the server may be configured to determine the location of the mobile device(s) by the physical relation (i.e. relative positions) between the plurality of light sources and the mobile device(s). The present embodiment is advantageous in that the server may conveniently and efficiently determine the location(s) of the mobile device(s) by one or more of the mentioned techniques.

According to an embodiment of the present invention, the server may be configured to train the machine learning, ML, model by further inputting at least one property associated with at least one relation between the plurality of light sources and the at least one mobile device at the capture of the at least one first image, and wherein the at least one mobile device is further configured to perform the processing of the at least one second image by further inputting at least one property associated with at least one relation between the plurality of light sources and the at least one mobile device at the capture of the at least one second image, via the trained machine learning, ML, model. The present embodiment is advantageous in that the machine learning, ML, model may be further improved by the training which further comprise (physical) relation(s) between the plurality of light sources and the mobile device(s) as input.

According to an embodiment of the present invention, the at least one property may comprise at least one of a height of a ceiling of the indoor space, wherein the plurality of light sources is arranged in the ceiling of the indoor space, at least one spatial direction between the plurality of light sources and the at least one mobile device, and at least one object in at least one direction between the plurality of light sources and the at least one mobile device, wherein the at least one object at least partially occludes the at least one direction. The present embodiment is advantageous in that the extent of image processing for obfuscation purposes is dependent on the relation(s) between the plurality of light sources and the mobile device(s), resulting in an even further improved machine learning, ML, model for the resulting location obfuscation.

According to an embodiment of the present invention, the at least one mobile device is configured to determine at least one of the at least one property. Hence, the mobile device(s) may be configured to determine the property(ies) of the indoor space. The present embodiment is advantageous in that the property(ies) regarding the relation(s) between the plurality of light sources and the mobile device(s) do not need to be known a priori, and may be determined by the mobile device(s) in situ.

According to an embodiment of the present invention, the server may be arranged to receive at least one of the at least one property. Hence, the server may be configured to receive the property(ies) of the indoor space. The present embodiment is advantageous in that the property(ies) regarding the relation(s) between the plurality of light sources may be provided in advance, which may be particularly convenient in case the mobile device(s) cannot or is (are) unsuitable for determining the property(ies) in situ.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 schematically shows a system 100 for obfuscation of a position of at least one subject in an indoor space, and

FIG. 2 schematically shows a method 500 for obfuscation of a position of at least one subject in an indoor space.

### DETAILED DESCRIPTION

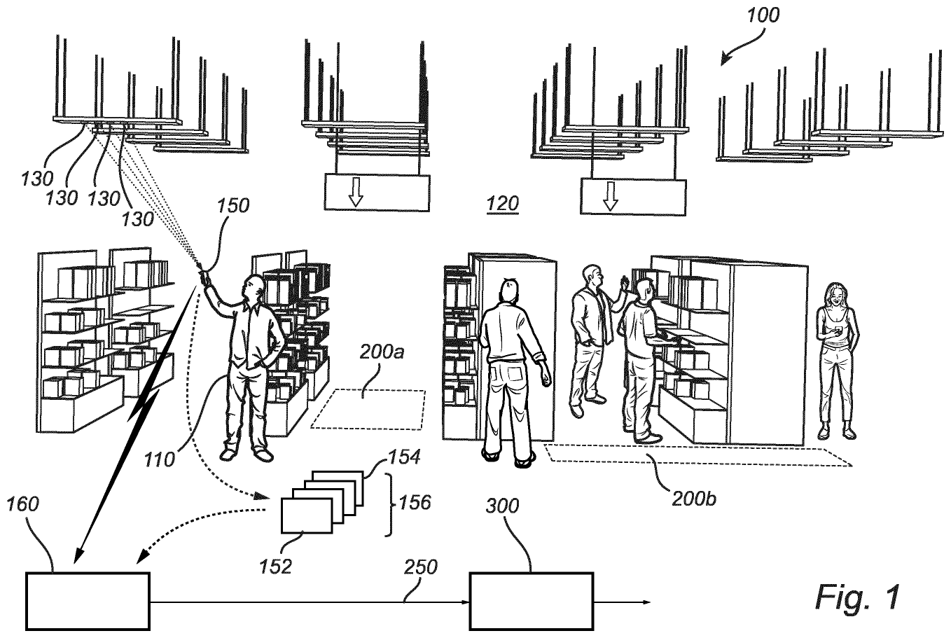

FIG. 1 schematically shows a system 100 for obfuscation of a position of at least one subject 110 in an indoor space 120. Here, the at least one subject 110 is exemplified as one (single) person 110, but it should be noted that the system 100 is applicable for substantially any subject (e.g. person, animal, object) and/or any number of subject(s) 110. The system 100 comprises a plurality of light sources 130, e.g. a plurality of light sources 130 comprising light-emitting diodes, LEDs, TLEDs, etc., which furthermore may be arranged in one or more luminaires. The plurality of light sources 130 is exemplified as being arranged in a ceiling of the indoor space 120. The indoor space 120 may be substantially any kind of indoor space 120 such as one or more rooms of an office, home or retail space. For example, the indoor space 120 may be a commercial space such as a warehouse, supermarket, shop or store. Each light source of the plurality of light sources 130 is configured to emit modulated illumination. Hence, the system 100 comprises a technology of coded light and/or visible light communication, VLC, whereby the system 100 uses visible light as a method of wirelessly transmitting data. It should be noted that details of coded light and/or VLC is known to the skilled person, and details thereof are hereby omitted.

The system 100 further comprises at least one mobile device 150 arranged to be portable by the person(s) 110. The mobile device 150 may be substantially any device intended to be carried (portable) by the person 110, such as a WTRU (e.g. mobile phone), a wearable device, a self-scanning device, etc. In particular, in case the indoor space 120 is a commercial space, the mobile device(s) 150 may preferably be a self-scanning device intended for scanning goods or items by the person 110. The mobile device 150 is configured to receive the modulated illumination from the plurality of light sources 130. The mobile device 150 is further configured to capture a plurality of images 156 comprising the modulated illumination. Hence, the mobile device 150 may receive the modulated illumination e.g. via a camera, receiver arrangement, or the like, of the mobile device 150.

The system 100 further comprises a server 160, as schematically indicated in FIG. 1, which is communicatively coupled to the mobile device(s) 150. It is understood that the server 160 may be positioned substantially anywhere, e.g. inside or outside the indoor space 120. The server 160 is configured to receive one or more first image(s) 152 of the plurality of images 156 captured by the mobile device(s) 150 and determine a location of the mobile device(s) 150 based on the modulated information of the first image(s) 152. For example, the server 160 may be configured to determine the location of the mobile device(s) 150 by triangulation, trilateration, multilateration, and/or fingerprinting. Additionally, or alternatively, the mobile device(s) 150 may receive an identification information (e.g., from the modulated illumination) from the at least one light source of the plurality of light sources and may determine the location of the mobile device(s) 150 based on the received identifier (identification information). The received identifier may comprise an identification information of the light source it is generated from.

The server 160 is further configured to receive information related to at least one zone 200a, 200b of the indoor space 120. In FIG. 1, there are two zones 200a, 200b in the indoor space 120, but it should be noted that the indoor space 120 may comprise substantially any number of zones 200a, 200b. The information comprises a predetermined privacy level associated with each zone 200a, 200b and a privacy threshold level. For example, in case the indoor space 120 is a commercial space such as a warehouse, as exemplified in FIG. 1, a first zone 200a may be a zone of the warehouse (e.g. an isle) having everyday goods such as vegetables, dairy products, pet foods, etc., and the first zone 200a may hereby be associated with a relatively low privacy level. In contrast, a second zone 200b of the warehouse (e.g. an isle) may comprise goods and/or items related to intimacy and/or privacy such as maternity tests, drugs/medicaments, etc., and the second zone 200b may hereby be associated with a relatively high privacy level.

The server 160 is configured to determine if the determined location of the mobile device(s) 150 is within a zone 200a, 200b of the indoor space 120, and if the determined location of the mobile device(s) 150 is within the zone 200a, 200b of the indoor space, determine if the privacy level associated with the zone 200a, 200b is above the privacy threshold level. For example, the server 160 may determine that the mobile device 150 is located/present in the (second) zone 200b which is associated with a relatively high privacy level. If the privacy level associated with the zone (e.g. zone 200b) is above the privacy threshold level, the server 160 is configured to perform a processing of the first image(s) 152 received by the server 160 from the mobile device(s) 150. It should be noted that zone 200b (e.g. an isle or area for medicine products) may comprise an additional area (e.g. 3-7 meter radius) for triggering the processing of the first image(s) 152 by the server 160, e.g. if a subject 110 leaves the zone 200a with a relatively low privacy level and approaches the zone 200b.

The (image) processing performed by the server 160 may comprise a processing of the first image(s) 152 by a shifting of at least a portion of the first image(s) 152 and/or an obfuscation of the first image(s) 152. The shifting of the at least a portion of the first image(s) 152 may comprise a shifting of elements, objects, or the like, in the respective first image(s) 152. The shifting of the first image(s) 152 as performed by the server 160 may comprise different levels of mean and variance. Alternatively, or in combination with the shifting of elements, objects, or the like, the shifting of the at least a portion of the first image(s) 152 may comprise a random shifting of pixels of the at least a portion of the first image(s) 152. Furthermore, the obfuscation of the first image(s) 152 may comprise a masking, a blurring, etc. of the first image(s) 152. It should be noted that the obfuscation may be irreversible to ensure privacy protection of the subject(s) (person(s)) 110, and may comprise algorithms such as Random Obfuscation Function (ROF), k-anonymity, N-rand, N-mix, Ellipsoid Random Obfuscation Function (EROF), etc.

The server 160 is further configured to perform a determination of an offset in accuracy of the location of the mobile device(s) 150 based on the processing of the first image(s) 152. In other words, based on the processed (shifted and/or obfuscated) first image(s) 152, the server 160 may determine the amount of offset in location accuracy that the applied amount of processing results in. For example, the server 160 may be configured to perform the determination of an offset in accuracy based on (or as a function of) the first image(s) (i.e. as unprocessed first image(s)) and the processed first image(s). For example, the server 160 may determine a length (e.g. in meters) of the offset in accuracy of the location of the mobile device(s) 150, such as 1 m, 2 m, or 5 m. The machine learning model may learn the relationship between the shifting/obfuscation of the at least a portion of the at least one first image and the offset in accuracy of the location of the at least one mobile device based on thereon. The learning is based on training of the machine learning model based on different samples/dataset comprising image shifting/obfuscation and a respective offset in accuracy of the location.

The server 160 is further configured to train a machine learning, ML, model 300 by inputting the offset in accuracy 250 of the location of the mobile device(s) 150 based on the processing of the first image(s) 152. Hence, the server 160 may train the machine learning, ML, model 300 (e.g. in the form of a regression or neural network model) by using the offset in accuracy 250 of the location of the mobile device(s) 150 (based on the processing of the first image(s) 152) as input.

The mobile device(s) 150 is further configured to perform a processing of at least one second image 154 of the plurality of images 156 via the trained machine learning, ML, model 300. For example, the second image(s) 154 may have been captured by mobile device(s) 150 of the subject 110, such as a (personal) mobile device 150, a scanning device, etc. Hence, after the server 160 has trained the machine learning, ML, model 300 by using the offset in accuracy 250 of the location of the mobile device(s) 150 as input, the trained machine learning, ML, model 300 is used by the mobile device(s) 150 for processing the second image(s) 154.

Hence, the mobile device(s) 150 itself (themselves) deploys a processing of the second image(s) 154 using the trained machine learning, ML, model 300. The second image(s) 154 is (are) hereby processed by the mobile device(s) 150, and may be sent to the server 160. Consequently, the mobile device(s) 150 may achieve a desired processing (shifting/obfuscation) of the second image(s) 154 in order to achieve a desired level obfuscation dependent on the location of the subject 110 with respect to the privacy levels of the zones 200a, 200b.

The server 160 of the system 100 may furthermore be configured to train the machine learning, ML, model 300 by further inputting at least one property associated with at least one relation between the plurality of light sources 130 and the mobile device(s) 150 at the capture of the first image(s) 152. The property(ies) may, for example, comprise a height of a ceiling of the indoor space 120 whereby the plurality of light sources 130 is arranged in the indoor space 120 ceiling, at least one direction between the plurality of light sources 130 and the mobile device(s) 150, at least one direction between sources of daylight (e.g. windows of the indoor space 120) and the mobile device(s) 150, and/or object(s) in at least one (spatial) direction between the plurality of light sources 130 and the mobile device(s) 150, wherein the object(s) at least partially occlude(s) (i.e. blocks) the direction(s). Hence, according to the last example, the property(ies) may comprise at least one (obstructing) object in a direction between the plurality of light sources 130 and the mobile device(s) 150 (for example, in case one or more objects is occluding the light sources 130). It should be noted that the mobile device(s) 150 may be configured to determine one or more of the property(ies). Alternatively, or in combination, the server 160 may be arranged to receive (information of) one or more of the property(ies). As an alternative to the training of the machine learning, ML, model 300 by inputting the propert(ies) as described, the server 160 of the system 100 may be configured to train the machine learning, ML, model 300 by further inputting at least one direction between sources of daylight (e.g. windows of the indoor space 120) and the mobile device(s) 150.

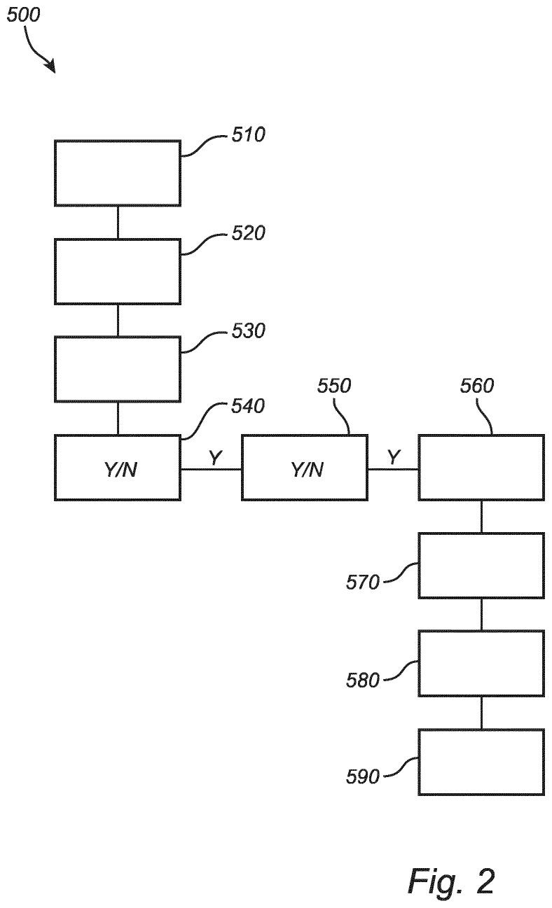

FIG. 2 schematically shows a method 500 for obfuscation of a position of at least one subject in an indoor space. It will be appreciated that the method 500 may be performed via a system 100 as described in FIG. 1 and the associated text, and it is therefore referred to this text and/or FIG. 1 for an increased understanding of the method 500.

The method 500 comprises receiving 510 at least one first image from the at least one mobile device. The method 500 further comprises determining 520 a location of the mobile device(s) based on the modulated information of the first image(s). The method 500 further comprises receiving 530 information related to at least one zone of the indoor space, wherein the information comprises a predetermined privacy level associated with each zone of the zone(s) and a privacy threshold level. It should be noted that the chronology of this step with respect to the other steps of the method 500 is an example, as the method 500 may receive this information earlier.

The method 500 further comprises determining 540 if the determined location of the at least one mobile device is within a zone of the indoor space, as indicated by “Y/N” (i.e. “Yes”/“No”) in FIG. 2. If the determined location of the at least one mobile device is within the zone of the indoor space (i.e. “Y”), the method 500 comprises determining 550 if the privacy level associated with the zone is above the privacy threshold level, as indicated by “Y/N”. If the privacy level associated with the zone is above the privacy threshold level (i.e. “Y”), the method 500 comprises performing a processing 560 of the first image(s) by a shifting of at least a portion of the first image(s) and/or an obfuscation of the first image(s). The method 500 further comprises performing a determination 570 of an offset in accuracy of the location of the mobile device(s) based on the processing of the first image(s). The method 500 further comprises training 580 of a machine learning, ML, model by inputting the offset in accuracy of the mobile device(s) based on the processing of the first image(s). The method 500 further comprises performing 590, via the at least one mobile device, a processing of at least one second image of the plurality of images via the trained machine learning, ML, model.

The person skilled in the art realizes that the present invention by no means is limited to the preferred embodiments described above. On the contrary, many modifications and variations are possible within the scope of the appended claims. For example, the indoor space 120 may comprise more zones than those indicated in FIG. 1, and/or the zones 200a, 200b may have different shapes and/or sizes than those depicted/described.

1. A system for obfuscation of a position of at least one subject in an indoor space via a visible light communication (VLC) based positioning, comprising
a plurality of light sources, wherein each light source of the plurality of light sources is configured to emit modulated illumination,
at least one mobile device arranged to be portable by the at least one subject, wherein each mobile device of the at least one mobile device is configured to
receive the modulated illumination from at least one light source of the plurality of light sources and capture a plurality of images comprising the modulated illumination,
a server communicatively coupled to the at least one mobile device, wherein the server is configured to
receive at least one first image of the plurality of images from the at least one mobile device and determine a location of the at least one mobile device based on the modulated information of the at least one first image,
receive information related to at least one zone of the indoor space, wherein the information comprises a predetermined privacy level associated with each zone of the at least one zone and a privacy threshold level,
determine if the determined location of the at least one mobile device is within a zone of the indoor space, and if the determined location of the at least one mobile device is within the zone of the indoor space, determine if the privacy level associated with the zone is above the privacy threshold level, and if the privacy level associated with the zone is above the privacy threshold level, configured to perform
a processing of the at least one first image by at least one of
a shifting of at least a portion of the at least one first image, and
an obfuscation of the at least one first image, and
a determination of an offset in accuracy of the location of the at least one mobile device based on the processing of the at least one first image, wherein the server is arranged for determining the amount of offset in location accuracy that the applied amount of processing results in,
train a machine learning, ML, model by inputting the offset in accuracy of the location of the at least one mobile device based on the processing of the at least one first image,
wherein the at least one mobile device is further configured to
perform a processing of at least one second image of the plurality of images by the trained machine learning, ML, model.

2. The system according to claim 1, wherein the indoor space is one of a warehouse, a supermarket, a shop, and a store.

3. The system according to claim 1, wherein the at least one mobile device is one of a wireless transmit/receive unit, WTRU, a wearable device, and a scanning device.

4. The system according to claim 1, wherein the shifting of the at least a portion of the at least one first image comprises random shifting of pixels of the at least a portion of the at least one first image.

5. The system according to claim 1, wherein the obfuscation of the at least one first image is performed as a function of the privacy level associated with the zone.

6. The system according to claim 1, wherein the obfuscation of the at least one first image comprises at least one of a masking and a blurring of the at least one first image.

7. The system according to claim 1, wherein the server is configured to determine the location of the at least one mobile device by one of a triangulation, trilateration, multilateration, and fingerprinting process.

8. The system according to claim 1, wherein the server is configured to train the machine learning, ML, model by further inputting at least one property associated with at least one relation between the plurality of light sources and the at least one mobile device at the capture of the at least one first image, and
wherein the at least one mobile device is further configured to
perform the processing of the at least one second image by further inputting at least one property associated with at least one relation between the plurality of light sources and the at least one mobile device at the capture of the at least one second image, via the trained machine learning, ML, model.

9. The system according to claim 8, wherein the at least one property comprises at least one of
a height of a ceiling of the indoor space, wherein the plurality of light sources is arranged in the ceiling of the indoor space,
at least one spatial direction between the plurality of light sources and the at least one mobile device, and
at least one object in at least one direction between the plurality of light sources and the at least one mobile device, wherein the at least one object at least partially occludes the at least one direction.

10. The system according to claim 8, wherein the at least one mobile device is configured to determine at least one of the at least one property.

11. The system according to claim 8, wherein the server is arranged to receive at least one of the at least one property.

12. A method for obfuscation of a position of at least one subject in an indoor space via a system using a visible light communication (VLC) based positioning, comprising
a plurality of light sources, wherein each light source of the plurality of light sources is configured to emit modulated illumination,
at least one mobile device arranged to be portable by the at least one subject, wherein each mobile device of the at least one mobile device is configured to
receive the modulated illumination from at least one light source of the plurality of light sources and capture a plurality of images comprising the modulated illumination, wherein the method comprises
receiving at least one first image of the plurality of images from the at least one mobile device and determining a location of the at least one mobile device based on the modulated information of the at least one first image,
receiving information related to at least one zone of the indoor space, wherein the information comprises a predetermined privacy level associated with each zone of the at least one zone and a privacy threshold level,
determining if the determined location of the at least one mobile device is within a zone of the indoor space, and if the determined location of the at least one mobile device is within the zone of the indoor space, determining if the privacy level associated with the zone is above the privacy threshold level, and if the privacy level associated with the zone is above the privacy threshold level, performing
a processing of the at least one first image by at least one of
a shifting of at least a portion of the at least one first image, and
an obfuscation of the at least one first image, and
a determination of an offset in accuracy of the location of the at least one mobile device based on the processing of the at least one first image, wherein the determination is based on determining the amount of offset in location accuracy that the applied amount of processing results in,
training of a machine learning, ML, model by inputting the offset in accuracy of the location of the at least one mobile device based on the processing of the at least one first image, and
performing, via the at least one mobile device, a processing of at least one second image of the plurality of images by the trained machine learning, ML, model.

13. The method according to claim 12, wherein the shifting of the at least a portion of the at least one first image comprises random shifting of pixels of the at least a portion of the at least one first images.

14. The method according to claim 12, wherein the obfuscation of the at least one first image is performed as a function of the privacy level associated with the zone.

15. The method according to claim 12, wherein the obfuscation of the at least one first image comprises at least one of a masking and a blurring of the at least one first image.
